(19) United States
(12) Patent Application Publication
(10) Pub. No.: US 2006/0235189 A1
(43) Pub. Date: Oct. 19, 2006

(54) Polyesters comprising groups that can be activated by actinic radiation, corresponding method and use

(75) Inventors: Heinz-Peter Rink, Munster (DE); Susanne Neumann, Munster (DE); Uwe Meisenburg, Dulsburg (DE); Karl-Heinz Joost, Drensteinfurt (DE); Dietmar Haring, Schriesheim (DE); Bernhard Hauer, Fussgonheim (DE)

Correspondence Address: BASF CORPORATION, 1609 BIDDLE AVENUE, WYANDOTTE, MI, 48192, US

(73) Assignee: Basf Coatings Aktiengesellschaft,, Munster (DE)

(21) Appl. No.: 10/542,228

(22) PCT Filed: Jan. 23, 2004
(86) PCT No.: PCT/EP04/00541

§ 371 Date: Nov. 2, 2005

(30) Foreign Application Priority Data
Feb. 5, 2003 (DE) 10304625.9

(51) Int. Cl. C08G 63/00

(52) U.S. Cl. 528/274; 427/508; 524/700

(57) ABSTRACT

Polyesters comprising at least one pendant and/or terminal group which can be activated with actinic radiation, preparable by reacting 1. a polyester (i) containing at least one pendant and/or terminal hydroxyl group with at least one carboxylic acid (i) or at least one ester (i) of a carboxylic acid (i) containing at least one bond which can be activated with actinic radiation, or 2. a polyester (ii) containing at least one pendant and/or terminal carboxylic acid group or at least one pendant and/or terminal carboxylic ester group with at least one hydroxyl-containing compound (ii) containing at least one bond which can be activated with actinic radiation in the presence of at least one organism and/or enzyme which catalyzes the transesterification or esterification; process for preparing them, and their use.

The present invention relates to novel polyesters containing groups which can be activated with actinic radiation. The present invention also relates to a novel process for preparing polyesters containing groups which can be activated with actinic radiation. The present invention further relates to the use of the novel polyesters as or to prepare novel compositions curable with actinic radiation. The present invention additionally relates to the use of the novel compositions curable with actinic radiation as coating materials, adhesives, and sealants for producing coatings, adhesive films and seals, and also for producing moldings and self-supporting films.

Polyesters which contain at least one pendant and/or terminal group which can be activated with actinic radiation have been known for a long time. They are used for preparing compositions curable with actinic radiation which are used in turn as coating materials, adhesives, and sealants for producing coatings, adhesive films, and seals and also for producing moldings and self-supporting films.

The polyesters may be prepared by polymer-analogous reactions of hydroxyl-containing polyesters with carboxylic acids or carboxylic esters containing bonds which can be activated with actinic radiation, such as acrylic acid or acrylic esters, for example, or of polyesters containing pendant and/or terminal carboxylic acid groups or carboxylic ester groups with hydroxyl compounds containing bonds which can be activated with actinic radiation, such as hydroxyethyl acrylate, for example.

Owing to their advantageous performance properties, polymers containing at least one pendant and/or terminal group which can be activated with actinic radiation are frequently used for preparing compositions curable with actinic radiation. Preparing them by the above-described polymer-analogous reactions is problematic, however, since the direct reaction of hydroxyl-containing polyesters with carboxylic acids or carboxylic ester groups can lead to a cleavage of the polyester. Likewise, the reaction of polyesters containing carboxylic acid groups or carboxylic ester groups with hydroxyl-containing compounds such as hydroxyethyl acrylate can lead to a reduction in molecular weight. The resulting polyesters can then no longer be used for preparing compositions curable with actinic radiation, since these compositions no longer meet user requirements.

European patent application EP 0 999 299 A1 discloses the preparation of (meth)acrylic esters of polyoxyalkylenes by esterification of acrylic acid and/or methacrylic acid or transesterification of (meth)acrylic esters with polyoxyalkylene glycols in the presence of an enzyme which catalyzes the (trans)esterification.

European patent application EP 0 999 230 A1 discloses the preparation of (meth)acrylic esters of hydroxy-functional siloxanes and/or polyoxyalkylene-modified siloxanes by esterification of acrylic acid and/or methacrylic acid or transesterification of (meth)acrylic esters with hydroxy-functional siloxanes and/or polyoxyalkylene-modified siloxanes in the presence of an enzyme which catalyzes the (trans)esterification.

European patent application EP 1 035 153 A1 discloses the preparation of (meth)acrylic esters of siloxanes modified with linear polyesters and containing carbonate groups by esterification of acrylic acid and/or methacrylic acid or transesterification of (meth)acrylic esters with siloxanes modified with linear polyesters and containing carbonate groups, and/or polyoxyalkylene-modified siloxanes, in the presence of an enzyme which catalyzes the (trans)esterification.

The article by Th. Laiot, M. Brigodiot and E. Marechal in Polymer Bulletin, Volume 26, pages 55 to 62, 1991 discloses the lipozyme-catalyzed transesterification of oligo(methyl acrylates) with allyl alcohol. In that case only the terminal ester groups are reacted.

Whether and, if so, to what extent these reactions can be transferred to the preparation of polyesters containing groups which can be activated with actinic radiation is unknown.

It is an object of the present invention to find novel polyesters containing at least one pendant and/or terminal group which can be activated with actinic radiation that no longer have the disadvantages of the prior art but which can instead be prepared by means of a gentle process which is advantageous in safety terms and which does not involve any damage, in particular any reduction in molecular weight, of the polyesters. Furthermore, the novel polyesters ought to have an advantageously low viscosity.

The novel polyesters ought in particular to be suitable as or to prepare compositions curable with actinic radiation. The novel compositions curable with actinic radiation ought to have a high solids content and be suitable in particular as coating materials, adhesives, and sealants for producing coatings, adhesive films and seals, and also for producing moldings and self-supporting films.

The invention accordingly provides the novel polyesters containing at least one pendant and/or terminal group which can be activated with actinic radiation, preparable by reacting
1. a polyester (i) containing at least one pendant and/or terminal hydroxyl group with at least one carboxylic acid (i) or at least one ester (i) of a carboxylic acid (i) containing at least one bond which can be activated with actinic radiation, or
2. a polyester (ii) containing at least one pendant and/or terminal carboxylic acid group or at least one pendant and/or terminal carboxylic ester group with at least one hydroxyl-containing compound (ii) containing at least one bond which can be activated with actinic radiation
   in the presence of at least one organism and/or enzyme which catalyzes the transesterification or esterification.

The novel polyesters containing at least one pendant and/or terminal group which can be activated with actinic radiation are referred to below as “polyesters of the invention”.

The invention also provides the novel process for preparing polyesters containing at least one pendant and/or terminal group which can be activated with actinic radiation by reacting
1. a polyester (i) containing at least one pendant and/or terminal hydroxyl group with at least one carboxylic acid (i) or at least one ester (i) of a carboxylic acid (i) containing at least one bond which can be activated with actinic radiation, or

2. a polyester (ii) containing at least one pendant and/or terminal carboxylic acid group or at least one pendant and/or terminal carboxylic ester group with at least one hydroxyl-containing compound (ii) containing at least one bond which can be activated with actinic radiation

in the presence of a catalyst, the catalyst being at least one enzyme which catalyzes the transesterification or esterification and/or at least one organism which catalyzes the transesterification or esterification.

The novel process for preparing polyesters containing at least one pendant and/or terminal group which can be activated with actinic radiation is referred to below as “process of the invention”.

Further subject matter of the invention will emerge from the description. In the light of the prior art it was surprising and unforeseeable for the skilled worker that the object on which the present invention is based could be achieved by means of the polyesters of the invention and by means of the process of the invention.

In particular, the polyesters of the invention showed no damage caused by the preparation process, in particular no reduction in molecular weight.

The process of the invention gave the polyesters of the invention in a manner which was particularly gentle and particularly advantageous from a safety standpoint. There was no damage, in particular no reduction in molecular weight, of the polyesters. Moreover, by means of the process of the invention it was possible to gain outstanding reproduction of the profile of properties of the polyesters of the invention that is necessary for the particular end use.

The novel polyesters were outstandingly suitable in particular as or to prepare compositions curable with actinic radiation. The novel compositions curable with actinic radiation were suitable in particular as coating materials, adhesives, and sealants for producing coatings, adhesive films, and seals and also for producing moldings and self-supporting films.

The coatings, adhesive films, seals, moldings, and self-supporting films of the invention have outstanding performance properties.

The products of the invention are oligomeric or polymeric polyesters.

Oligomers contain generally 2 to 15 monomeric units; polymers contain generally more than 10 monomeric units (cf. also Römpp Online, 2002, “oligomers”, “polymers”).

The polyesters of the invention contain at least one pendant and/or terminal group which can be activated with actinic radiation. They preferably contain at least two pendant and/or terminal groups of this kind.

For the purposes of the present invention, actinic radiation means electromagnetic radiation, such as near infrared (NIR), visible light, UV radiation, x-rays, and gamma radiation, especially UV radiation, and corpuscular radiation, such as electron beams, proton beams, alpha radiation, beta radiation, and neutron beams, especially electron beams.

In the case of the polyesters of the invention obtainable by the first variant of the process of the invention, the groups which can be activated with actinic radiation are linked to the main chain of the oligomer or polymer via carbonyloxy groups —C(O)—O—, as viewed from the groups which can be activated with actinic radiation.

In the case of the polyesters of the invention obtainable by the second variant of the process of the invention, the groups which can be activated with actinic radiation are linked to the main chain of the oligomer or polymer via carbonyloxy groups —C(O)—O—, as viewed from the main chains.

The groups which can be activated with actinic radiation contain at least one, especially one, bond which can be activated with actinic radiation. By this is meant a bond which on exposure to actinic radiation becomes reactive and, with other activated bonds of its kind, enters into polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds or carbon-carbon triple bonds. Of these, the carbon-carbon double bonds and triple bonds are advantageous and are therefore used with preference in accordance with the invention. The carbon-carbon double bonds are particularly advantageous and so are used with particular preference. For the sake of brevity they are referred to below as “double bonds”.

The double bonds are preferably contained in groups of the general formula I: 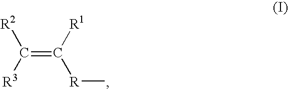
in which the variables are defined as follows:
R is a bonding electron pair between the olefinic carbon atom and the carbon atom of a carbonyloxy group or linking organic radical, preferably a bonding electron pair; and
R¹, R²
and R³ are hydrogen atoms or organic radicals;
   it being possible for at least two of the radicals R, R¹, R², and R³ to be linked cyclically to one another.

Examples of suitable linking organic radicals R comprise or consist of alkylene, cycloalkylene and/or arylene groups. Highly suitable alkylene groups contain one carbon atom or 2 to 6 carbon atoms. Highly suitable cycloalkylene groups contain 4 to 10, especially 6, carbon atoms. Highly suitable arylene groups contain 6 to 10, especially six, carbon atoms.

Examples of suitable organic radicals R¹, R², and R³ comprise or consist of alkyl, cycloalkyl and/or aryl groups. Highly suitable alkyl groups contain one carbon atom or 2 to 6 carbon atoms. Highly suitable cycloalkyl groups contain 4 to 10, especially 6, carbon atoms. Highly suitable aryl groups contain 6 to 10, especially 6, carbon atoms.

The organic radicals R, R¹, R², and R³ may be substituted or unsubstituted. However, the substituents must not disrupt the implementation of the process of the invention and/or inhibit the activation of the groups with actinic radiation. Preferably, the organic radicals R, R¹, R², and R³ are unsubstituted.

Examples of especially suitable groups of the general formula I are vinyl, 1-methylvinyl, 1-ethylvinyl, propen- 1-yl, styryl, cyclohexenyl, endomethylenecyclohexyl, norbornenyl, and dicyclopentadienyl groups, especially vinyl groups.

Accordingly, the particularly preferred groups which can be activated with actinic radiation are (meth)acrylate, ethacrylate, crotonate, cinnamate, cyclohexenecarboxylate, endomethylenecyclohexanecarboxylate, norbornenecarboxylate, and dicyclopentadienecarboxylate groups, but particularly (meth)acrylate groups, especially acrylate groups. In the case of the polyesters of the invention obtainable by the first variant of the process of the invention, these groups are connected directly to the oligomer or polymer main chains (R in the general formula I is a bonding electron pair between the olefinic carbon atom and the carbon atom of the carbonyloxy group). In the case of the polyesters of the invention obtainable by the second variant of the process of the invention, these groups are connected to the main chains of the polyesters via a linking organic radical and an oxycarbonyl group —O—C(O)—.

The polyesters of the invention are preparable by polymer-analogous reactions.

In the first variant of the process of the invention a polyester (i) containing at least one pendant and/or terminal hydroxyl group, preferably at least two and in particular at least three pendant and/or terminal hydroxyl groups, is reacted with at least one carboxylic acid (i) or at least one ester (i) of a carboxylic acid (i) which contains at least one, especially one, of the above-described bonds which can be activated with actinic radiation.

In the second variant of the process of the invention a polyester (ii) containing at least one pendant and/or terminal carboxylic acid group, preferably at least two and in particular at least three pendant and/or terminal carboxylic acid groups, or at least one pendant and/or terminal carboxylic ester group, preferably at least two and in particular at least three pendant and/or terminal carboxylic ester groups, is reacted with at least one, especially one, hydroxyl-containing compound (ii) containing at least one, especially one, of the above-described bonds which can be activated with actinic radiation.

For the polyesters of the invention and also for the process of the invention it is essential that the reactions are carried out in the presence, as catalyst, of at least one, especially one, enzyme which catalyzes the (trans)esterification and/or at least one, especially one, organism which catalyzes the (trans)esterification.

Enzymes used are hydrolases [EC 3.x.x.x], especially esterases [EC 3.1.x.x] and proteases [EC 3.4.x.x]. Preference is given to the carboxyl ester hydrolases [EC 3.1.1.x]. Particular preference is given to using lipases as hydrolases. Use is made in particular of lipases from Achromobacter sp., Aspergillus sp., Burkholderia sp., Candida sp., Mucor sp., Penicillium sp., Pseudomonas sp., Rhizopus sp., Thermomyces sp. or porcine pancrease. The enzymes and their functions are described for example in Römpp Online, 2002, “hydrolases”, “lipases”, and “proteases”. They may be mobilized or immobilized.

Suitable organisms include all naturally occurring or genetically modified microorganisms, single-celled life forms or cells which catalyze the (trans)esterification by means of a hydrolase [EC 3.x.x.x], preferably of an esterase [EC 3.1.x.x] or protease [EC 3.4.x.x], more preferably of a carboxyl ester hydrolase [EC 3.1.1.x], and in particular of a lipase. Use may be made of any organisms known to the skilled worker which comprise hydrolases. Preference is given to using organisms which comprise lipases as hydrolases. Use is made in particular of Achromobacter sp., Aspergillus sp., Burkholderia sp., Candida sp., Mucor sp., Penicillium sp., Pseudomonas sp., Rhizopus sp., Thermomyces sp. and cells from porcine pancrease. The organisms may be the unmodified organisms themselves and cells or genetically modified organisms which originally do not express the enzymes at all or not with sufficient strength and which exhibit sufficiently high enzyme activity and productivity only after modification. Additionally, the organisms may be adapted by the genetic modification to the conditions of reaction and/or culturing.

The amount of the enzyme and/or organism used may vary widely and is guided by the requirements of the case in hand, in particular by the reactivity of the starting products, the catalytic activity and selectivity of the enzyme and/or organism, and the conditions chosen.

The enzyme is used preferably in an amount of from 0.1 to 20%, more preferably from 0.2 to 16%, with particular preference from 0.2 to 14%, with very particular preference from 0.3 to 12%, and in particular from 0.5 to 10% by weight, based in each case on the total amount of the starting products.

The process of the invention can be carried out with any of a wide variety of polyesters (i) or (ii). Examples of suitable polyesters and their preparation are described for example in German patent application DE 42 04 518 A1, page 4 line 43 to page 5 line 2.

Any of a very wide variety of carboxylic acids (i) or carboxylic esters (i) and hydroxyl-containing compounds (ii) may be used in the process of the invention. It is essential that these compounds contain at least one, especially one, bond which can be activated with actinic radiation. The carboxylic acids (i) or carboxylic esters (i) and the hydroxyl-containing compounds (ii) are preferably selected from the group consisting of compounds of the general formula II: 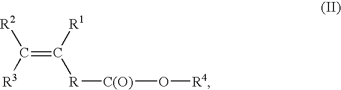
in which the variables R, R¹, R², and R³ are as defined above and the variable R⁴
1. in the case of the carboxylic acids (i) stands for a hydrogen atom and in the case of the carboxylic esters (i) for a hydroxyl-free, monovalent organic radical and
2. in the case of the hydroxyl-containing compounds (ii) stands for a hydroxyl-containing, monovalent organic radical.

The monovalent organic radical R⁴ preferably comprises or consists of
1. in the case of the carboxylic esters (i) at least one radical selected from the group consisting of hydroxyl-free alkyl, cycloalkyl, and aryl radicals, and
2. in the case of the hydroxyl-containing compounds (ii) at least one radical selected from the group consisting of hydroxyl-containing alkyl, cycloalkyl, and aryl radicals, especially such radicals containing primary hydroxyl groups.

Examples of suitable alkyl, cycloalkyl, and aryl radicals are those described above. It is preferred to use alkyl radicals R⁴. More preferably, the hydroxyl-free alkyl radical R⁴ is a methyl, ethyl, propyl, butyl or 2-ethylhexyl radical, in particular a methyl radical, and the hydroxyl-containing alkyl radical R⁴ is a hydroxyethyl, a 2- or 3-hydroxypropyl or 4-hydroxybutyl radical, in particular a 4-hydroxybutyl radical.

The carboxylic acids (i) are preferably selected from the group consisting of acrylic acid, methacrylic acid, ethacrylic acid, crotonic acid, cinnamic acid, cyclohexenecarboxylic acid, endomethylenecyclohexanecarboxylic acid, norbornenecarboxylic acid, and dicyclopentadienecarboxylic acid, especially acrylic acid.

The carboxylic esters (i) are preferably selected from the group consisting of hydroxyl-free esters of acrylic acid, methacrylic acid, ethacrylic acid, crotonic acid, cinnamic acid, cyclohexenecarboxylic acid, endomethylenecyclohexanecarboxylic acid, norbornenecarboxylic acid, and dicyclopentadienecarboxylic acid, especially of acrylic acid.

The hydroxyl-containing compounds (ii) are preferably selected from the group consisting of hydroxyl-containing esters of acrylic acid, methacrylic acid, ethacrylic acid, crotonic acid, cinnamic acid, cyclohexenecarboxylic acid, endomethylenecyclohexanecarboxylic acid, norbornenecarboxylic acid, and dicyclopentadienecarboxylic acid, especially of acrylic acid.

In particular, the carboxylic acid (i) is acrylic acid, the carboxylic ester (i) is methyl acrylate, and the hydroxyl-containing compound (ii) is 4-hydroxybutyl acrylate.

The molar ratio of the polyesters (i) to the carboxylic acids or to the carboxylic esters (i) and also the molar ratio of the polyesters (ii) to the hydroxyl-containing compounds (ii) may vary very widely and are guided by the requirements of the case in hand, in particular by the number of reactive functional groups in the polyesters (i) and (ii), by the target degree of conversion of the reactive functional groups, and by the intended application. The skilled worker is therefore easily able to determine the molar proportions appropriate to the particular case on the basis of his or her general art knowledge, where appropriate with the assistance of a few rangefinding tests.

The reactions according to the process of the invention can be carried out in a single-phase or multiphase, aqueous and/or organic reaction medium. The starting products may be present in solution, suspension or emulsion. The reactions can be carried out with or without addition of solvent. It is preferred to use solvents which are inert in respect of the reactions. Preference is given to using conventional organic solvents, especially aprotically nonpolar solvents. It is also possible to use an excess of carboxylic acids (i) or carboxylic esters (i) or of hydroxyl-containing compounds (ii) as reaction medium. With particular preference the reactions are carried out in bulk, i.e., in the absence of organic solvents or in the presence of small amounts.

The process of the invention can be carried out at different temperatures. The selection of the temperature range is guided by the requirements of the case in hand, in particular by the reactivity of the starting products and their thermal stability and also by the catalytic activity and selectivity of the enzyme and/or organism and its thermal stability. The process of the invention is preferably carried out at temperatures from 0 to 100° C., more preferably from 10 to 80° C., with particular preference from 15 to 75° C., and in particular from 20 to 70° C.

The duration of the reactions may also vary widely and is likewise guided by the requirements of the case in hand, in particular by the reactivity of the starting products and by the catalytic activity and selectivity of the enzyme and/or organism. Preferably, the duration is from one hour to one week, more preferably from two hours to five days, with particular preference from three hours to four days, and in particular from four hours to three days.

The process of the invention can be carried out in batch mode, in which case all of the starting products are charged to an appropriate reaction vessel, or in semibatch mode, in which case some or all of the starting products are metered in to the reaction medium during the course of the reaction.

The reaction according to the first and second variants of the process of the invention is accompanied by the formation of water or of at least one compound, in particular a hydroxyl-containing compound, such as methanol, ethanol, propanol or butanol. It is advisable to remove the hydroxyl-containing compound or the water which forms from the reaction mixtures during or immediately after its formation. This can be done using any conventional method, such as vacuum distillation or azeotropic distillation, pervaporation or transmission of inert gases, for example. It is essential here that the starting products, the catalysts, and the end products do not suffer thermal damage. It is also possible to add substances to the reaction mixtures which absorb hydroxyl-containing compounds and/or water. These substances, however, must not disrupt the process of the invention by, for example, reducing the catalytic activity of the enzyme and/or organism and/or developing their own catalytic activity. Examples of suitable absorbents are molecular sieves of appropriate pore size (cf. also Römpp Online, 2002, “molecular sieves” and “zeolites”).

The resultant polyesters of the invention may be put to any of a wide variety of end uses. For these purposes they may be isolated from the reaction mixtures as substances or used directly in solution. They are preferably used as or to prepare novel compositions curable with actinic radiation. The novel compositions curable with actinic radiation are referred to below as “compositions of the invention”.

The compositions of the invention may comprise any conventional constituents of compositions curable with actinic radiation, such as additional radiation-curable binders, different than the polyesters of the invention, radiation-curable reactive diluents, and photoinitiators. They may further comprise conventional auxiliaries and additives, such as catalysts, plasticizers, light stabilizers, adhesive promoters (tackifiers), slip additives, leveling agents, polymerization inhibitors, flatting agents, nanoparticles, and film-forming auxiliaries.

Examples of suitable conventional constituents of compositions curable with actinic radiation or both thermally and with actinic radiation (dual cure) are known for example from German patent DE 197 09 467 C1, page 4 line 30 to page 6 line 30, or German patent application DE 199 47 523 A1.

Where the composition of the invention can also be cured thermally, i.e., is a dual-cure composition, it preferably further comprises conventional thermosetting binders and crosslinking agents, which may additionally contain groups which can be activated with actinic radiation, and/or thermosetting reactive diluents, as is described for example in German patent applications DE 198 187 735 A1 and DE 199 20 799 A1 or European patent application EP 0 928 800 A1.

The compositions of the invention are preferably prepared by mixing the above-described constituents in suitable mixing units such as stirred tanks, stirrer mills, extruders, compounders, Ultraturrax, inline dissolvers, static mixers, micromixers, toothed-wheel dispersers, pressure release nozzles and/or microfluidizers. In the course of this mixing it is preferred to operate in the absence of light with a wavelength λ<550 nm or in complete absence of light, so as to prevent premature crosslinking of the compositions of the invention.

The compositions of the invention may be present in any of a wide variety of forms. Thus, they are conventional compositions containing organic solvents, aqueous compositions, substantially or completely solvent-free and water-free liquid compositions (100% systems), substantially or completely solvent-free and water-free solid powders, or substantially or completely solvent-free powder suspensions (powder slurries). Moreover, they may be one-component systems, in which the binders and the crosslinking agents are present alongside one another, or two-component or multicomponent systems, in which the binders and the crosslinking agents are separate from one another until shortly before application.

The compositions of the invention are used for producing materials cured with actinic radiation, especially coatings, moldings, and self-supporting films.

To produce the moldings and self-supporting films of the invention, the compositions of the invention are applied to conventional temporary or permanent substrates. For producing the self-supporting films and moldings of the invention it is preferred to use conventional temporary substrates, such as metal belts, plastic belts or hollow bodies made of metal, glass, plastic, wood or ceramic, which can be easily removed without damaging the self-supporting films and moldings of the invention.

Where the compositions of the invention are used for producing coatings, adhesive films and seals, permanent substrates are employed, such as means of transport, including aircraft, boats, rail vehicles, muscle-powered vehicles and motor vehicles, and parts thereof, the interior and exterior of buildings and parts thereof, doors, windows, and furniture, and, in the context of industrial coating, substrates such as hollow glassware, coils, freight containers, packaging, small industrial parts, such as nuts, bolts or hubcaps, optical components, electrical components, such as wound goods, including coils and stators and rotors of electric motors, mechanical components, and components for white goods, including household appliances, boilers, and radiators. The self-supporting films and moldings of the invention may likewise serve as substrates.

In terms of method, the application of the liquid compositions of the invention has no special features but can instead take place by any conventional application method, such as spraying, squirting, knife coating, brushing, flow coating, dipping, trickling or rolling, for example.

The application of the compositions of the invention in powder form also has no particular features as far as its method is concerned but instead takes place, for example, by the conventional fluid-bed techniques, such as are known, for example, from the BASF Coatings AG brochures “Pulverlacke für industrielle Anwendungen”, January 2000, or “Coatings Partner, Pulverlack Spezial”, 1/2000, or Römpp Lexikon Lacke und Druckfarben, Georg Thieme Verlag, Stuttgart, N.Y., 1998, pages 187 and 188, “electrostatic powder spraying”, “electrostatic spraying”, and “electrostatic fluidized-bath process”.

During application it is advisable to operate in the absence of actinic radiation in order to prevent premature crosslinking of the composition of the invention.

The applied compositions of the invention are preferably cured using UV radiation. During irradiation it is preferred to use a radiation dose of from 100 to 6 000, more preferably from 200 to 3 000, more preferably still from 300 to 2 000, and with particular preference from 500 to 1 800 mJ cm⁻², the region <1 700 mJ cm⁻² being especially preferred.

The intensity of radiation may vary widely. It is guided in particular by the radiation dose on the one hand and the irradiation time on the other. For a given radiation dose, the irradiation time is guided by the belt speed or rate of advance of the substrates in the irradiation unit, and vice versa.

As radiation sources for UV radiation it is possible to use all conventional UV lamps. Flash lamps are also suitable. As UV lamps it is preferred to use mercury vapor lamps, more preferably medium and high pressure mercury vapor lamps, especially medium pressure mercury vapor lamps. Particular preference is given to using unmodified mercury vapor lamps plus appropriate filters or modified, especially doped, mercury vapor lamps.

Preference is given to using gallium-doped and/or iron-doped, especially iron-doped, mercury vapor lamps, as described for example in R. Stephen Davidson, “Exploring the Science, Technology and Applications of UV and EB Curing”, Sita Technology Ltd., London, 1999, Chapter I, “An Overview”, page 16, FIG. 10, or Dipl.-Ing. Peter Klamann, “eltosch System-Kompetenz, UV-Technik, Leitfaden für Anwender”, page 2, October 1998.

Examples of suitable flash lamps are flash lamps from the company VISIT.

The distance of the UV lamps from the applied compositions of the invention may varying surprisingly widely and can therefore be tailored very effectively to the requirements of the case in hand. The distance is preferably from 2 to 200, more preferably from 5 to 100, with particular preference from 10 to 50, and in particular from 15 to 30 cm. The lamp arrangement may also be adapted to the circumstances of the substrate and the process parameters. In the case of substrates of complex shape, as are envisaged for automobile bodies, those regions not accessible to direct radiation (shadow regions), such as cavities, folds, and other structural undercuts, may be cured using pointwise, small-area or all-round emitters, in conjunction with an automatic movement means for the irradiation of cavities or edges.

Irradiation may be carried out under an oxygen-depleted atmosphere. “Oxygen-depleted” means that the oxygen content of the atmosphere is less than the oxygen content of air (20.95% by volume). In principle the atmosphere may also be oxygen-free—that is, made up of an inert gas. Owing to the absence of the inhibitory effect of oxygen, however, this may cause sharp acceleration of radiation curing, possibly leading to inhomogeneties and stresses in the cured materials of the invention. It is therefore of advantage not to lower the oxygen content of the atmosphere to zero % by volume.

In the case of the applied dual-curable compositions of the invention, the thermal cure may take place, for example, with the aid of a gaseous, liquid and/or solid, hot medium, such as hot air, heated oil or heated rollers, or with the aid of microwave radiation, infrared light and/or near infrared (NIR) light. Heating preferably takes place in a forced-air oven or by irradiation using IR and/or NIR lamps. As in the case of the actinic radiation cure, the thermal cure may also take place in stages. The thermal cure takes place advantageously at temperatures from room temperature to 200° C.

Both the thermal cure and the actinic radiation cure may be carried out in stages. They may follow one another (sequentially) or be simultaneous. In accordance with the invention, sequential curing is of advantage and is therefore used with preference. It is particularly advantageous in this case to carry out the thermal cure after the actinic radiation cure.

The resultant self-supporting films, moldings, coatings, adhesive films, and seals of the invention are outstandingly suitable for the coating, adhesive bonding, sealing, wrapping, and packaging of means of transport, including aircraft, boats, rail vehicles, muscle-powered vehicles and motor vehicles, and parts thereof, the interior and exterior of buildings and parts thereof, doors, windows, and furniture, and, in the context of industrial coating, substrates such as hollow glassware, coils, freight containers, packaging, small industrial parts, such as nuts, bolts or hubcaps, optical components, electrical components, such as wound goods, including coils and stators and rotors of electric motors, mechanical components, and components for white goods, including household appliances, boilers, and radiators.

In particular, however, the compositions of the invention are used, as coating materials, preferably as surfacers, primers, basecoat and topcoat or clearcoat materials, preferably as topcoat materials or clearcoat materials, especially as clearcoat materials for producing multicoat color and/or effect, electrically conductive, magnetically shielding or fluorescent paint systems, especially multicoat color and/or effect paint systems. For producing the multicoat paint systems it is possible to employ conventional wet-on-wet techniques and coating system constructions.

The resultant clearcoats of the invention are the outermost coats of the multicoat paint systems, which essentially determine the overall appearance and protect the color and/or effect coats against mechanical and chemical damage and damage due to radiation. Consequently, deficiencies in the hardness, scratch resistance, chemical stability, and yellowing stability are manifested to a particularly severe extent in the clearcoat. However, the yellowing of the clearcoats of the invention is minimal. They are highly scratch resistant and, after exposure to scratching, exhibit only very small losses of gloss. At the same time they have a high hardness. Not least, they have a particularly high chemical resistance and adhere very firmly to the color and/or effect coats.

The substrates of the invention which are impregnated and/or coated with coatings of the invention, adhesively bonded with adhesive films of the invention, sealed with seals of the invention and/or packaged or wrapped with self-supporting films and/or moldings of the invention therefore have outstanding long-term service properties and a particularly long service life.

### EXAMPLES

### Example 1

The preparation of a Polyester Containing Acrylate Groups

A reactor suitable for polyester preparation was charged with 1050.9 parts by weight of phthalic anhydride, 452.2 parts by weight of neopentylglycol, 228.4 parts by weight of hexanediol and 289.8 parts by weight of trimethylolpropane and this initial charge was subjected to continuous condensation until a hydroxyl number of 180 mg KOH/g was reached. The polyester was then drained from the reactor.

In a reaction vessel, 200 parts by weight of the polyester, 30 parts by weight of methyl isobutyl ketone, 140 parts by weight of methyl acrylate, 0.028 part by weight of methylhydroquinoline, 16 parts by weight of Novozym® 435 (lipase from Novozyme, Denmark) and 100 parts by weight of 5-Angstrom molecular sieve were mixed with one another and stirred at 40° C. for 24 hours. The molecular sieve was then filtered off and the product was washed with a little methyl acrylate. Excess methyl acrylate and 4-methoxyphenol were removed from the filtrate by vacuum distillation at 40° C. The remaining polyester, which contained acrylate groups, had a hydroxyl number of 65 mg KOH/g, corresponding to a conversion of 64%.

The acrylate-functional polyester was outstandingly suitable for the preparation of UV-curable compositions.

### Example 2

The Preparation of a UV-Curable and Heat-Curable (Dual Cure) Clearcoat Material and Production of a Multicoat Color Paint System From it

For the preparation of the dual-cure clearcoat material, first of all a hydroxyl-containing polyacrylate resin was prepared. For that purpose a steel reactor suitable for the polymerization and equipped with stirrer, reflux condenser, and oil heating was charged with 810 parts by weight of Solventnaphtha® and this initial charge was heated to the polymerization temperature of 140° C. Thereafter, over the course of 4.75 hours, a mixture of 148.2 parts by weight of tert-butyl peroxy-2-ethylhexanoate and 111 parts by weight of Solventnaphtha® was metered in. 15 minutes after commencement of the feeding of the initiator mixture, a mixture of 185 parts by weight of styrene, 862 parts by weight of ethylhexyl acrylate, 500 parts by weight of hydroxyethyl methacrylate, 278 parts by weight of hydroxybutyl acrylate and 28 parts by weight of acrylic acid were metered in over 4 hours. After the end of the polymerization the solution was adjusted with further Solventnaphtha® to a solids content of 65% by weight. The polyacrylate resin had a hydroxyl number of 175 mg KOH/g.

For the preparation of the dual-cure clearcoat material, additionally, a stock varnish was prepared from 35 parts by weight of the hydroxyl-containing polyacrylate resin, 30 parts by weight of the acrylate-functional polyester of Example 1, 2.9 parts by weight of an Aerosil® paste, 1 part by weight of Irgacure® (commercial photoinitiator), 0.5 part by weight of Lucirin® TPO (commercial photoinitiator from BASF Aktiengesellschaft), 0.8 part by weight of Byk® 358 (commercial coatings additive from Byk Chemie), 1 part by weight of Tinuvin® 292 and 1 part by weight of Tinuvin® 400 (both commercial light stabilizers from Ciba Specialty Chemicals), and 22.8 parts by weight of butyl acetate.

Furthermore, a curing agent solution was prepared from 64 parts by weight of isocyanato acrylate Roskydal® UA VPLS 2337 (basis: trimer of hexamethylene diisocyanate; isocyanate group content: 12% by weight), 16 parts by weight of isocyanato acrylate Roskydal® UA VP FWO 303-77 (basis: trimer of isophorone diisocyanate, 70.5% strength in butyl acetate, viscosity: 1500 mPas; isocyanate group content: 6.7% by weight) and 11.5 parts by weight of Desmodur® N 3300 (isocyanate based on the trimer on hexamethylene diisocyanate) (all three products from Bayer AG), and 8 parts by weight of butyl acetate.

Stock varnish and curing agent were mixed in a weight ratio of 95:36.5 to give the dual-cure clearcoat material.

To produce the multicoat paint system, steel panels were coated in succession with an electrocoat, deposited cathodically and baked at 170° C. for 20 minutes, in a dry film thickness of 18 to 22 μm. Thereafter the steel panels were coated with a commercial two-component waterborne surfacer from BASF Coatings AG, such as is normally used for plastics substrates. The resultant surfacer film was baked at 90° C. for 30 minutes to give a dry film thickness of 35 to 40 μm. Thereafter a commercial black aqueous basecoat material from BASF Coatings AG was applied, with a film thickness of 12 to 15 μm, after which the resultant aqueous basecoat film was flashed off at 80° C. for 10 minutes. The dual-cure clearcoat material was then applied pneumatically using a gravity-feed cup-type gun in one cross pass, with a film thickness of 40 to 45 μm. The aqueous basecoat film and the clearcoat film were cured at room temperature for 5 minutes, at 80° C. for 10 minutes, followed by irradiation with UV light in a dose of 1 500 mJ/cm², and finally at 140° C. for 20 minutes.

The multicoat paint system was very bright and had a gloss (20°) to DIN 67530 of 89.7. Moreover, the clearcoat was free from surface defects, possessed a high level of adhesion to the basecoat, and was hard, flexible, scratch-resistant, weathering-stable, chemicals-resistant, yellowing-resistant, and resistant to bird droppings.

1. A polyester comprising at least one pendant and/or terminal group which can be activated with actinic radiation, comprising the reaction product of at least one of
1. a polyester (i) containing at least one of a pendant and/or terminal hydroxyl group reacted with at least one of carboxylic acid (i) and one ester (i) of a carboxylic acid (i) each containing at least one bond which can be activated with actinic radiation, and
2. a polyester (ii) containing at least one of a pendant and/or terminal carboxylic acid group and a pendant and/or terminal carboxylic ester group reacted with at least one hydroxyl-containing compound (ii) containing at least one bond which can be activated with actinic radiation
in the presence of at least one of an organism and an enzyme which catalyzes the transesterification or esterification.

2. The polyester as claimed in claim 1, wherein the enzyme is selected from the group consisting of hydrolases [EC 3.x.x.x].

3. The polyester as claimed in claim 2, wherein the hydrolases [EC 3.x.x.x], are selected from the group consisting of esterases [EC 3.1.x.x] and proteases [EC 3.4.x.x].

4. The polyester as claimed in claim 3, wherein the hydrolases are carboxyl ester hydrolases [EC 3.1.1.x].

5. The polyester as claimed in claim 4, wherein the hydrolases are lipases.

6. The polyester as claimed in claim 5, wherein the lipases are obtained-from at least one of Achromobacter sp., Aspergillus sp., Burkholderia sp., Candida sp., Mucor sp., Penicillium sp., Pseudomonas sp., Rhizopus sp., Thermomyces sp. and porcine pancrease.

7. The polyester as claimed in claim 1, wherein the organisms are selected from the group consisting of naturally occurring microorganisms, genetically modified microorganisms, single-cell life forms and cells which comprise at least one enzyme which catalyzes the transesterification or esterification.

8. The polyester as claimed in claim 7, wherein the organisms are selected from the group consisting of Achromobacter sp., Aspergillus sp., Burkholderia sp., Candida sp., Mucor sp., Penicillium sp., Pseudomonas sp., Rhizopus sp., Thermomyces sp., and cells from porcine pancrease.

9. The polyester as claimed in claim 1, wherein the carboxylic acid (i), the carboxylic ester (i), and the hydroxyl-containing compound (ii) each contain a bond which can be activated with actinic radiation.

10. The polyester as claimed in claim 1, wherein the bond which can be activated with actinic radiation is at least one of a carbon-carbon double bond and a triple bond.

11. The polyester as claimed in claim 10, wherein the bond which can be activated with actinic radiation is a carbon-carbon double bond.

12. The polyester as claimed in claim 1, wherein the carboxylic acid (i) is a monocarboxylic acid and the hydroxyl-containing compound (ii) contains a primary hydroxyl group.

13. The polyester as claimed in claim 1, wherein the bond which can be activated with actinic radiation is present in groups of the general formula I: 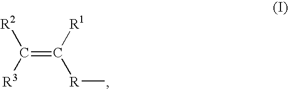
in which the variables are defined as follows:
R is a bonding electron pair between the olefinic carbon atom and the carbon atom of a carbonyloxy group and linking organic radical; and
R¹, R²
and R³ are hydrogen atoms or organic radicals;
it being possible for at least two of the radicals R, R¹, R², and R³ to be linked cyclically to one another.

14. The polyester as claimed in claim 13, wherein the carboxylic acids (i) or carboxylic esters (i) and the hydroxyl-containing compounds (ii) are selected from the group consisting of compounds of the general formula II: 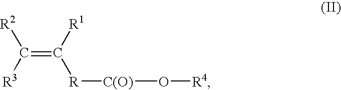
in which the variables R, R¹, R², and R³ are as defined above and the variable R⁴
1. in the case of the carboxylic acids (i) stands for a hydrogen atom and in the case of the carboxylic esters (i) for a hydroxyl-free, monovalent organic radical and
2. in the case of the hydroxyl-containing compounds (ii) stands for a hydroxyl-containing, monovalent organic radical.

15. The polyester as claimed in claim 14, wherein the monovalent organic radical R⁴ comprises or consists of
1. in the case of the carboxylic esters (i) at least one radical selected from the group consisting of hydroxyl-free alkyl, cycloalkyl, and aryl radicals, and
2. in the case of the hydroxyl-containing compounds (ii) at least one radical selected from the group consisting of hydroxyl-containing alkyl, cycloalkyl, and aryl radicals.

16. The polyester as claimed in claim 14, wherein the carboxylic acid (i) is acrylic acid, the carboxylic ester (i) is methyl acrylate, and the hydroxyl-containing compound (ii) is 4-hydroxybutyl acrylate.

17. A process for preparing a polyester as claimed in claim 1 comprising at least one of a pendant and/or a terminal group which can be activated with actinic radiation, comprising reacting at least one of
1. a polyester (i) containing at least one of a pendant and/or terminal hydroxyl group reacted with at least one of a carboxylic acid (i) and one ester (i) of a carboxylic acid (i) each containing at least one bond which can be activated with actinic radiation, and
2. a polyester (ii) containing at least one of a pendant and/or terminal carboxylic acid group and a pendant and/or terminal carboxylic ester group reacted with at least one hydroxyl-containing compound (ii) each containing at least one bond which can be activated with actinic radiation
in the presence of a catalyst, the catalyst being at least one of an enzyme which catalyzes the transesterification or esterification and organism(s) which catalyze(s) the transesterification or esterification.

18. The process as claimed in claim 17, wherein the water produced during the esterification of the polyesters (i) and (ii) or the resultant hydroxyl-containing compounds is or are removed from the reaction mixture as they are forming or immediately after they have formed.

19. A composition curable with actinic radiation or both thermally and with actinic radiation comprising a polyester as claimed in claim 1.

20. A composition selected from the group consisting of a coating material, adhesive and, sealing compounds for producing a coating, adhesive films, seals, moldings and self-supporting film comprising the composition of claim 19.
